(19) United States
(12) Patent Application Publication
(10) Pub. No.: US 2014/0185230 A1
(43) Pub. Date: Jul. 3, 2014

(54) COMPUTER ENCLOSURE WITH SECURITY PLATE

(71) Applicants: Hon Hai Precision Industry Co., Ltd., New Taipei (TW); Hong Fu Jin Precision Industry (Shenzhen) Co., Ltd., Shenzhen (CN)

(72) Inventors: XIANG YU, Shenzhen (CN); XIAO-YONG MA, Shenzhen (CN)

(73) Assignees: Hon Hai Precision Industry Co., Ltd., New Taipei (TW); Hong Fu Jin Precision Industry (Shenzhen) Co., Ltd., Shenzhen (CN)

(21) Appl. No.: 14/024,887

(22) Filed: Sep. 12, 2013

(30) Foreign Application Priority Data
Dec. 28, 2012 (CN) 2012105824403

(51) Int. Cl. G06F 1/18

(52) U.S. Cl. CPC G06F 1/182
USPC 361/679.45

(57) ABSTRACT

A computer enclosure includes a chassis and a security plate. The chassis includes a side plate and a rear plate. The rear plate defines a plurality of openings configured for providing accesses to a plurality of I/O ports. The security plate is movably connected to the side plate. When the security plate is in the locked position, the security plate covers the rear plate and blocks one or more of the plurality of openings and one or more of the plurality of I/O ports cannot be accessed. When the security plate is in the unlocked position, the security plate is away from the rear plate and the plurality of I/O ports can be accessed.

### REFERENCE TO RELATED APPLICATIONS

This application claims all benefits accruing under 35 U.S.C. §119 from China Patent Application No. 201210582440.3 filed on Dec. 28, 2012 in the State Intellectual Property Office of China, the contents of the China Application are hereby incorporated by reference.

### BACKGROUND

1. Technical Field

The present disclosure generally relates to computer enclosures, and particularly relates to computer enclosures with a security plate.

2. Description of Related Art

In today's world, computers are an essential part of almost every business. Computers control, manage, operate, and assist individuals in many different tasks. For example, computers assist in generating a marketing analysis, monitoring readout signals, displaying results of analysis, allowing individuals to modify operations of other machines. Data stored in computers has become more and more important and valuable. However, data in computers is subject to theft because these computers can be easily accessed via exposed I/O ports by unauthorized persons.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a computer enclosure.

FIG. 2 is an assembled view of the computer enclosure of FIG. 1, showing the security plate in a locked position.

FIG. 3 is similar to FIG. 2, but viewed form a different aspect.

FIG. 4 is similar to FIG. 2, but showing the security plate in a unlocked position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

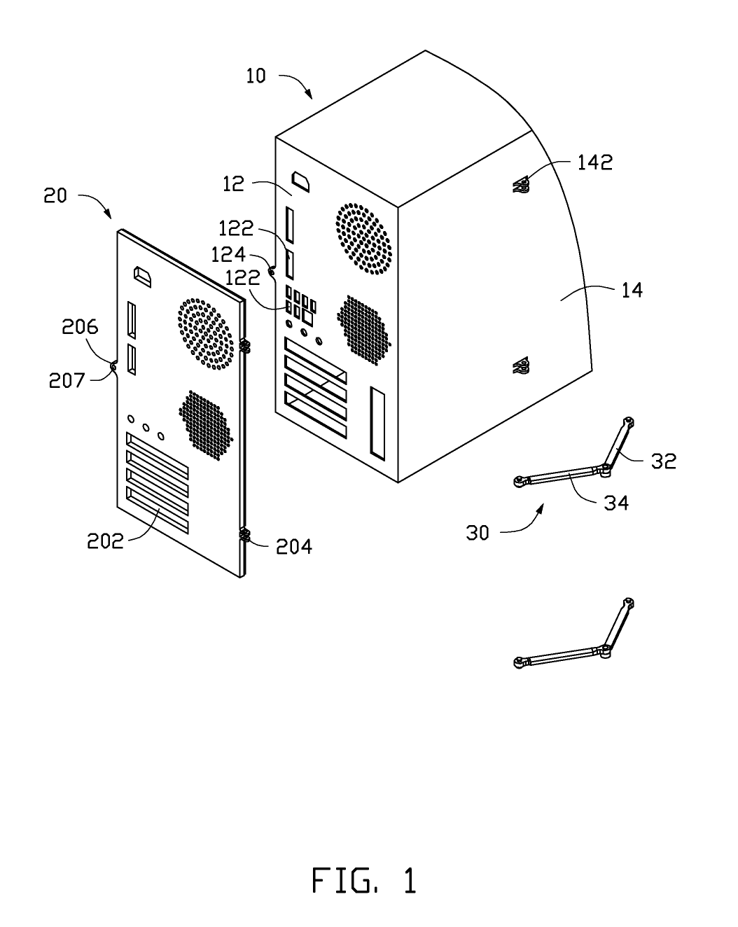

FIG. 1 shows an embodiment of a computer enclosure. The computer enclosure includes a chassis 10, a security plate 20, and a linkage mechanism 30.

The chassis 10 includes a rear plate 12 and a side plate 14. The rear plate 12 defines a plurality of first openings 122 configured for providing accesses to I/O ports. The I/O ports may be accessed via these first openings 122 of the rear plate 12. The rear plate 12 defines a through hole 124.

The side plate 14 is substantially perpendicular to the rear plate 12. A first mounting member 142 extends from an exterior surface of the side plate 14.

The security plate 20 defines a plurality of second openings 202. The number of the second openings 202 is less than the number of the first openings 122 of the rear plate 12. The width and length of the security plate 20 are substantially the same as the width and length of the rear plate 12.

A second mounting member 204 laterally extends from a first edge of the security plate 20. A locking tab 206 laterally extends from a second edge of the security plate 20. The locking tab 206 defines a locking hole 207.

The linkage mechanism 30 includes a first connecting bar 32 and a second connecting bar 34. A first end of the first connecting bar 32 is pivotally connected to a first end of the second connecting bar 34.

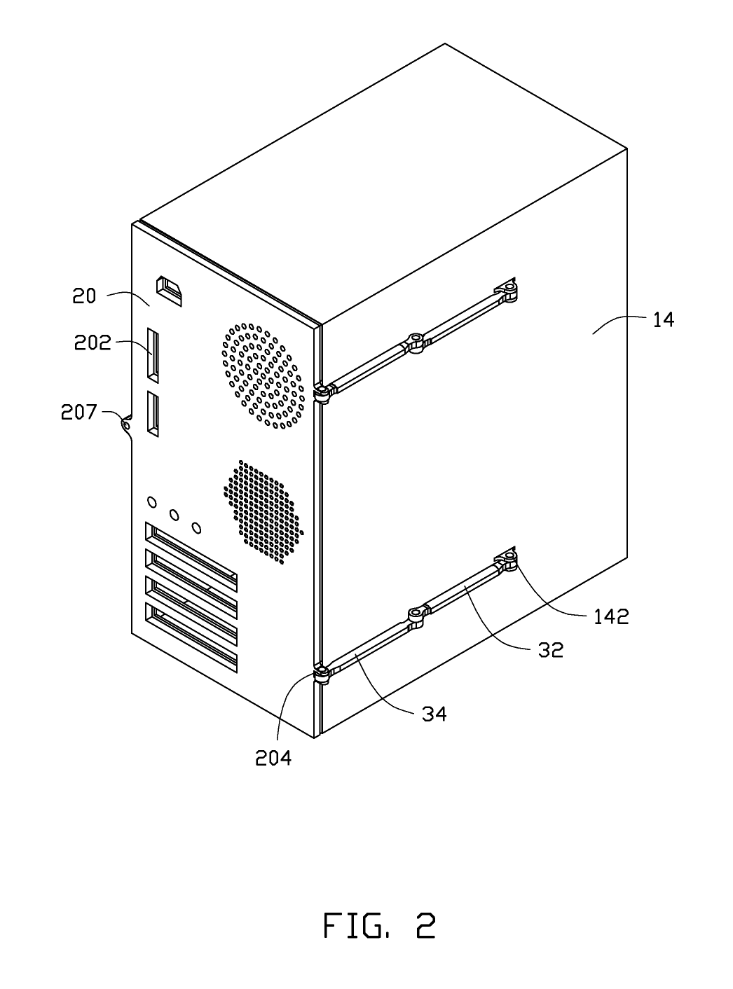

FIG. 2 shows that, in assembly, a second end of the first connecting bar 32 is pivotally connected to the first mounting member 142 and a second end of the second connecting bar 34 is pivotally connected to the second mounting member 204. Thus, the security plate 20 is movably connected to the side plate 14. The security plate 20 is movable between a locked position and an unlocked position.

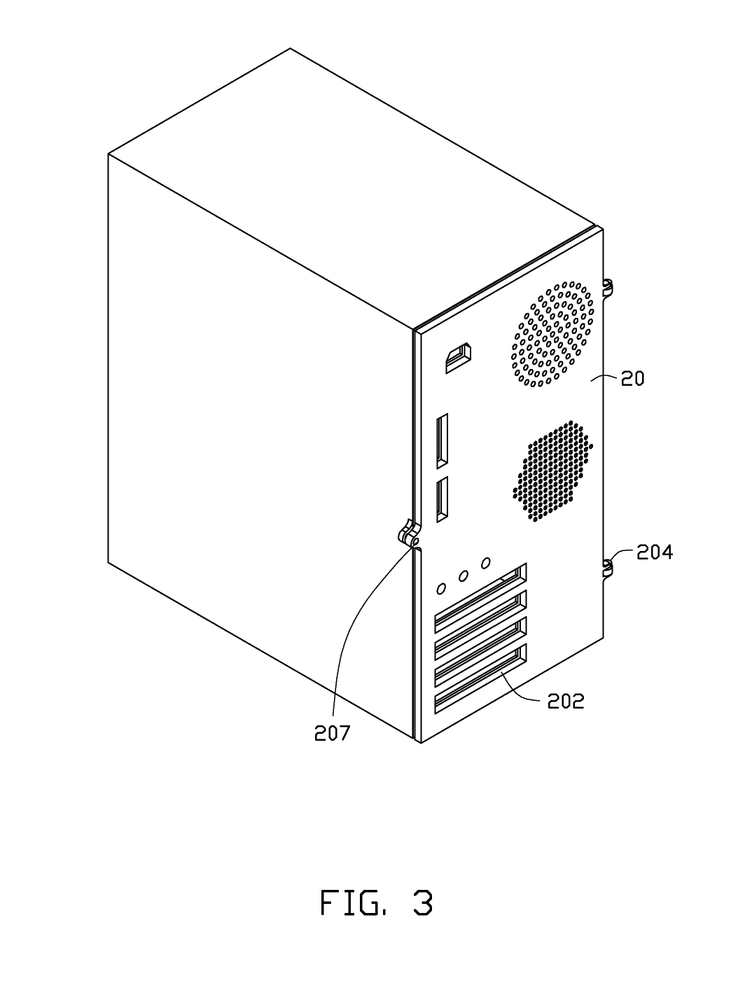

FIGS. 2 and 3 show that, when the security plate 20 is in the locked position, the security plate 20 covers the rear plate 12 and blocks one or more of the first openings 122 of the rear plate 12. Thus, one or more I/O ports are prevented from being accessed via the one or more blocked first openings 122. Due to the second openings 202 of the security plate 20, some of the first openings 122 of the rear plate 12 will not be blocked. Thus, when the security plate 20 is in the locked position, some of the I/O ports are still allowed to be accessed.

In some embodiments, when the security plate 20 is in the locked position, the first connecting bar 32 and the second connecting bar 34 are substantially in a straight line, which is perpendicular to the security plate 20.

In some embodiments, when the security plate 20 is in the locked position, the locking hole 207 of the locking tab 206 is aligned with and adjacent to the through hole 124 of the rear plate 12. A locking member (not shown), e.g., a lock, can be engaged with the locking hole 207 and the through hole 124 to lock the security plate 20 to the rear plate 12.

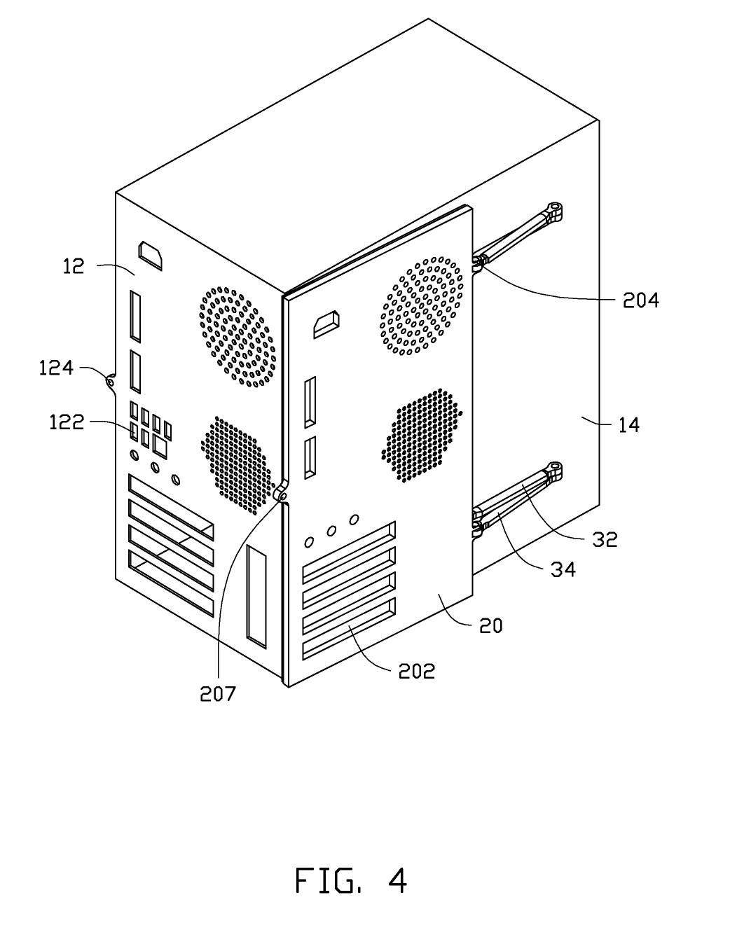

FIG. 4 shows that, when the security plate 20 is in the unlocked position, the security plate 20 is moved away from the rear plate 12. Thus, the I/O ports are allowed to be accessed via the first openings 122 of the rear plate 12.

In some embodiments, when the security plate 20 is in the unlocked position, the first connecting bar 32 and the second connecting bar 34 are folded together. The security plate 20 faces the side plate 14 and is close to the side plate 14. The security plate 20 and the side plate 14 are substantially in the same plane.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A computer enclosure, comprising:
a chassis comprising a side plate and a rear plate, the rear plate defining a plurality of openings configured for providing accesses to a plurality of I/O ports; and
a security plate movably connected to the side plate, the security plate being movable between a locked position and an unlocked position, wherein when the security plate is in the locked position, the security plate covers the rear plate and blocks one or more of the plurality of openings and the one or more of the plurality of I/O ports cannot be accessed, when the security plate is in the unlocked position, the security plate is away from the rear plate and the plurality of I/O ports can be accessed.

2. The computer enclosure of claim 1, further comprising a first connecting bar and a second connecting bar, wherein the first connecting bar is pivotally connected to the side plate, the second connecting bar is pivotally connected to the first connected bar, and the security plate is pivotally connected to the second connecting bar.

3. The computer enclosure of claim 2, wherein the chassis further comprises a first mounting member extending from an exterior surface of the side plate, the first connecting bar is pivotally connected to the first mounting member.

4. The computer enclosure of claim 3, further comprising a second mounting member laterally extending from a first edge of the security plate, wherein the second connecting bar is pivotally connected to the second mounting member.

5. The computer enclosure of claim 4, wherein the security plate is closer to the side plate when in the unlocked position than in the locked position.

6. The computer enclosure of claim 5, wherein when the security plate is in the unlocked position, the security plate and the side plate are substantially in the same plane.

7. The computer enclosure of claim 6, wherein when the security plate is in the unlocked position, the first connecting bar and the second connecting bar are folded together.

8. The computer enclosure of claim 7, wherein when the security plate is in the locked position, the first connecting bar and the second connecting bar are substantially in a straight line.

9. The computer enclosure of claim 8, wherein the security plate defines a locking hole, the rear plate defines a through hole, when the security plate is in the locked position, the locking hole is aligned with and adjacent to the through hole.

10. The computer enclosure of claim 1, wherein a width and a length of the security plate are substantially the same as a width and a length of the rear plate.

11. A computer enclosure, comprising:
a chassis comprising a side plate and a rear plate, the rear plate defining a plurality of openings configured for providing accesses to a plurality of I/O ports;
a linkage mechanism pivotally connected to the side plate; and
a security plate pivotally connected to the linkage mechanism, the security plate being movable between a locked position and an unlocked position, wherein when the security plate is in the locked position, the security plate covers the rear plate and blocks one or more of the plurality of openings and the one or more of the plurality of I/O ports cannot be accessed, when the security plate is in the unlocked position, the security plate is away from the rear plate and the plurality of I/O ports can be accessed.

12. The computer enclosure of claim 11, wherein the linkage mechanism comprises a first connecting bar and a second connecting bar, the first connecting bar is pivotally connected to the side plate, the second connecting bar is pivotally connected to the first connected bar, and the security plate is pivotally connected to the second connecting bar.

13. The computer enclosure of claim 12, wherein the chassis further comprises a first mounting member extending from an exterior surface of the side plate, the first connecting bar is pivotally connected to the first mounting member.

14. The computer enclosure of claim 13, further comprising a second mounting member laterally extending from a first edge of the security plate, wherein the second connecting bar is pivotally connected to the second mounting member.

15. The computer enclosure of claim 14, wherein the security plate is closer to the side plate when in the unlocked position than in the locked position.

16. The computer enclosure of claim 15, wherein when the security plate is in the unlocked position, the security plate and the side plate are substantially in the same plane.

17. The computer enclosure of claim 16, wherein when the security plate is in the unlocked position, the first connecting bar and the second connecting bar are folded together.

18. The computer enclosure of claim 17, wherein when the security plate is in the locked position, the first connecting bar and the second connecting bar are substantially in a straight line.

19. The computer enclosure of claim 18, wherein the security plate defines a locking hole, the rear plate defines a through hole, when the security plate is in the locked position, the locking hole is aligned with and adjacent to the through hole.

20. The computer enclosure of claim 11, wherein a width and a length of the security plate are substantially the same as a width and a length of the rear plate.
